(19) United States
(12) Patent Application Publication
(10) Pub. No.: US 2016/0282861 A1
(43) Pub. Date: Sep. 29, 2016

(54) METHOD FOR KEEPING DRONES WITHIN A DESIGNATED BOUNDARY

(71) Applicant: WolfGIS, LLC, Pell City, AL (US)

(72) Inventors: JOHN MICHAEL GOLDEN, Pell City, AL (US); TEMPLETON BRIGGS, III, Snohomish, WA (US)

(73) Assignee: WolfGIS, LLC, Pell City, AL (US)

(21) Appl. No.: 15/080,352

(22) Filed: Mar. 24, 2016

Related U.S. Application Data
(60) Provisional application No. 62/137,300, filed on Mar. 24, 2015.

(51) Int. Cl. G05D 1/00; G05D 1/10; B64C 39/02

(52) U.S. Cl. CPC G05D 1/0011; B64C 39/024; G05D 1/0022; G05D 1/101

(57) ABSTRACT

A Tract-Lock based drone location data system is described with inherent properties for providing precise drone location data and keeping drones within a designated geographic boundary.

### CROSS-REFERENCES TO RELATED APPLICATIONS

This application claims the benefit of U.S. Provisional Application No. 62/137,300, filed Mar. 24, 2015, which is incorporated herein by reference in its entirety.

### FIELD OF THE INVENTION

The present invention is generally directed to a system of devices using geo-positioning software and communication services of an electronic device to determine an earth-based location within a specified boundary. In greater particularity, the present invention relates to the calculation of geo-positioning boundaries with respect to a drone's current location on a geo-positionally known tract of land, and the subsequent override of the drone's flight instructions that would cause the drone to cross a boundary.

### BACKGROUND OF THE INVENTION

As the popularity of remote-controlled aircraft (commonly known as drones) has grown, there has been growing concern that the drones may enter areas that they should not, including restricted airspaces or private property where drones are not permitted.

The use of global position systems (GPS) to determine the terrestrial position of a portable device is well-known in the art. For instance, U.S. Pat. No. 5,375,059 to Kyrtsos et al., U.S. Pat. No. 5,438,517 to Sennott et al., and U.S. Pat. No. 5,490.073 to Kyrtsos each describe a navigational system for vehicles utilizing the electromagnetic signals received from GPS satellites. The aforementioned patents (U.S. Pat. No. 5,375,079; U.S. Pat. No. 5,438,517; U.S. Pat. No. 5,490,073) are hereby incorporated by reference.

Individual and enterprise use of drone aircraft for a wide variety of land and enterprise management activities is growing exponentially. Very recent National Safety Transportation Board (NSTB) granting of Federal Aviation Administration (FAA) authority to regulate drone use will result in strict limitations in altitude and airspace. The ability to ensure that a drone remains within permitted property or other designated boundaries will assist drone users in conforming to FAA regulations. A parallel problem is ensuring that a drone never enters restricted airspace.

Ensuring that drones remain within a boundary has particular challenges that are not faced by ground based vehicles. For example, from the perspective of a drone operator on the ground, the drone operator may not be able to see that his remote controlled drone has crossed a boundary into restricted airspace. Even if he is aware that the boundary is near, the wind may push the drone across the boundary.

### SUMMARY OF THE INVENTION

We disclose herein a system that restricts drones to a boundary. Although it is based on the same inventor's technology disclosed in U.S. Pat. No. 8,934,923, it addresses the additional and unique challenges faced by aircraft that are unanticipated by ground based devices. The system compares the drone's GPS location with the property or designated boundary polygon as defined by the latitude/longitude of the vertices, also called a geo-fence. The aforementioned pending patent application (U.S. Pat. No. 8,934,923) is incorporated herein by reference.

The geo-fences can be placed in drone-controller memory via a common communication method from an electronic device, or, in the case of the drone not having on-board microprocessor control, the drone would transmit its GPS location to the electronic device. Drone-based or base station-based drone flight control would override programmed or manual flight instructions that would cause the drone to cross a geo-fence into a restricted airspace. This method enables both keeping the drone within a designated permissible airspace and ensuring the drone never enters a designated restricted airspace.

### BRIEF DESCRIPTION OF THE DRAWINGS

Further advantages of the invention will become apparent by reference to the detailed description of preferred embodiments when considered in conjunction with the drawings:

FIG. 1 is a general communication system diagram showing how a drone located within a designated airspace is connected to various communication elements of the system.

### DETAILED DESCRIPTION

The following detailed description is presented to enable any person skilled in the art to make and use the invention. For purposes of explanation, specific details are set forth to provide a thorough understanding of the present invention. However, it will be apparent to one skilled in the art that these specific details are not required to practice the invention. Descriptions of specific applications are provided only as representative examples. Various modifications to the preferred embodiments will be readily apparent to one skilled in the art, and the general principles defined herein may be applied to other embodiments and applications without departing from the scope of the invention. The present invention is not intended to be limited to the embodiments shown, but is to be accorded the widest possible scope consistent with the principles and features disclosed herein.

This invention solves the problem of keeping drones within a boundary by using the inventor's Tract-Lock GPS technology. Tract-Lock was originally designed to assist ground-based workers, on foot or in vehicles, by continuously informing them, visually and audibly, whether they are within or outside the designated boundaries of a parcel or property. The GPS-based location of the person, as determined by the location services of a GPS-equipped device, such as but not limited to a smart phone or pad, is compared to the boundary of the designated parcel/property polygon as defined by the latitude and longitude of the vertices, with any number of simple algorithms.

The presently disclosed invention therefore ensures that any drone flight control possibilities, including but not limited to programmed, random, and manually-controlled flight, will conform to drone use regulations involving staying within property lines or other zone designations, and staying out of restricted areas.

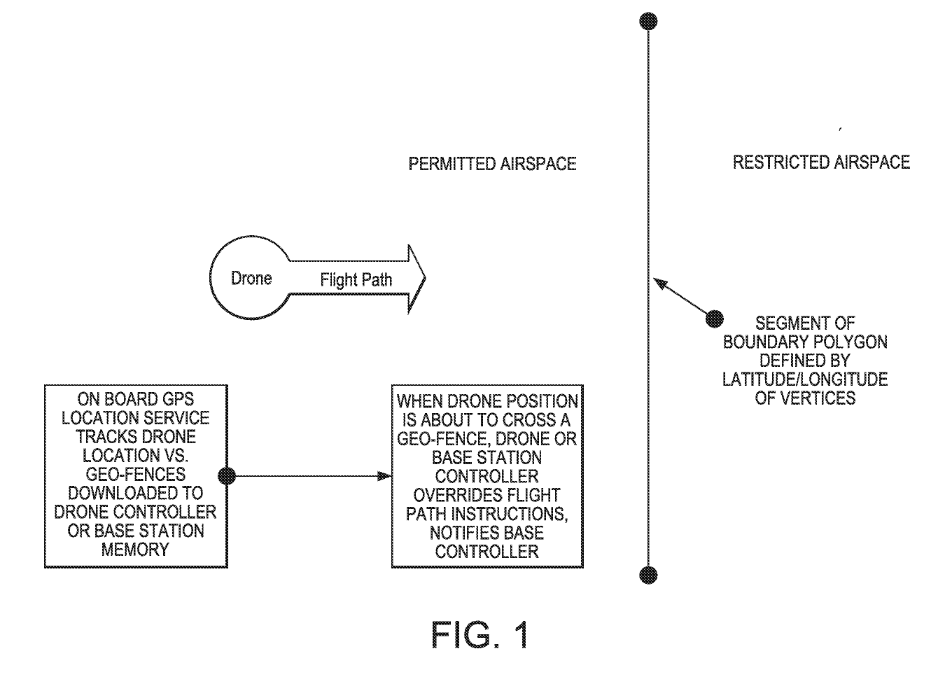

Referring to the drawings, FIG. 1. shows a schematic view of the communication infrastructure utilized by the present invention during typical use in a drone flight scenario. In this sample scenario, a drone is traveling and trying to remain within a permitted airspace by not crossing over a designated geographic boundary defined by latitude and longitude of polygon vertices. A software application on an electronic device communicates geo-positional data to a drone-based flight control or base station-based drone flight control.

The preferred embodiment of the system consists primarily of a drone, an electronic device, and a designated geographic boundary. Polygons vertices define the boundaries of permitted and restricted airspaces, or geo-fences.

More specifically, the boundary data set of geo-fences is created by pinpointing vertices of a polygon on a map of the flight path on a remote computing device and uploading the data set directly to the electronic device. The geo-fences are uploaded in drone-controller memory via a common communication method from an electronic device.

Examples of such communication methods include the use of cable, BlueTooth, WiFi, internet, and IR.

Examples of electronic devices include personal computers, smart mobile devices such as smartphones and tablets, and application specific proprietary devices.

Next in the preferred embodiment, software algorithms running in the drone's on board controller compare the drone's GPS location data based on its on-board GPS systems to the various installed geo-fences, both permitted and restricted airspace, and prevent the drone from crossing such a designated geographic boundary.

If the software application determines that the drone's current position is not within the designated permitted airspace, the drone-based flight controller will issue a warning and correct the drone's flight path to prevent it from crossing the designated geo-fence by overriding its programmed or manual flight instructions with a variety of possible flight responses, all of which keep the drone on the correct side of the boundary.

Such flight responses may include hovering on the correct side of the designated boundary when a programmed or manual flight command would carry it across the boundary and communicating such status to the base station in the case of an on-board microprocessor control.

Other flight responses may include landing when weather conditions, drone sub-system malfunctions, or other conditions prevent the execution of programmed or manual flight instructions without forcing the drone across a geo-fence. The drone could automatically resume its flight path when conditions allow. Input on weather conditions could come from on-board or base station sensors or flight control algorithms.

If the drone does not having an on-board microprocessor control, the drone transmits its GPS location data to an electronic device. The geo-fences are also created or otherwise present in the base station controller, and the control algorithms for this invention run in that device. Further, the base station controller issues the warning and corrects the drone's flight path when the drone enters into a restricted airspace.

In a potential embodiment of the system, the base station controller has a display showing the current and projected drone position relative to the geo-fences.

In programmed flight paths, this invention would allow software override when weather conditions, such as wind, would otherwise push the drone out of a permitted space or into a restricted zone. Additionally, the system could logically modify a programmed flight path within the drone's flight capabilities when weather or other conditions prevent the execution of programmed flight instructions. The logic may, for example, cut short a specific flight vector and move to the next planned vector within the permitted airspace.

Conversely, in manually controlled drone flight, this invention would allow an automatic override for commands which would otherwise place the drone outside of designated boundaries or cause an incursion into restricted airspace.

This system also allows for the creation of randomized flight paths within a designated area without allowing the drone to leave the area by comparing the drone's location to the designated geo-fences.

Further, this system could be applied within software during flight path design processes to ensure conformance to airspace regulation and could coded into drone on-board or base station drone control systems as a fail-safe method of conforming to airspace regulations.

The terms “comprising,” “including,” and “having,” as used in the claims and specification herein, shall be considered as indicating an open group that may include other elements not specified. The terms “a,” “an,” and the singular forms of words shall be taken to include the plural form of the same words, such that the terms mean that one or more of something is provided. The term “one” or “single” may be used to indicate that one and only one of something is intended. Similarly, other specific integer values, such as “two,” may be used when a specific number of things is intended. The terms “preferably,” “preferred,” “prefer,” “optionally,” “may,” and similar terms are used to indicate that an item, condition or step being referred to is an optional (not required) feature of the invention.

The invention has been described with reference to various specific and preferred embodiments and techniques. However, it should be understood that many variations and modifications may be made while remaining within the spirit and scope of the invention. It will be apparent to one of ordinary skill in the art that methods, devices, device elements, materials, procedures and techniques other than those specifically described herein can be applied to the practice of the invention as broadly disclosed herein without resort to undue experimentation. All art-known functional equivalents of methods, devices, device elements, materials, procedures and techniques described herein are intended to be encompassed by this invention. Whenever a range is disclosed, all subranges and individual values are intended to be encompassed. This invention is not to be limited by the embodiments disclosed, including any shown in the drawings or exemplified in the specification, which are given by way of example and not of limitation.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

All references throughout this application, for example patent documents including issued or granted patents or equivalents, patent application publications, and non-patent literature documents or other source material, are hereby incorporated by reference herein in their entireties, as though individually incorporated by reference, to the extent each reference is at least partially not inconsistent with the disclosure in the present application (for example, a reference that is partially inconsistent is incorporated by reference except for the partially inconsistent portion of the reference).

1. A method for providing the location of a drone pursuant to global positioning information, comprising:
a. a drone;
b. an electronic device having means for communicating wirelessly through the internet to a remote internet protocol address, means for determining a latitude and longitude of said drone, means for communicating over a cellular network, and means for controlling the internal electronics of said electronic device;
c. means for loading a geographic position boundary; and
d. means running on said electronic device for calculating a geographic position boundary upon the receipt of a land tract file holding geographic information representing the perimeter of a flight path represented by said land tract file, and wherein said boundary corresponds to said perimeter of said land tract.

2. The method of claim 1, further including means for accepting an uploaded land tract file and associated land tract file with said database record.

3. The method of claim 1, further comprising means for managing a plurality of land tract files associated with said drone and downloading said files into said electronic device upon request.

4. The method of claim 1 wherein said electronic device communicates the drone's location to a remote base controller.

5. The method of claim 1 wherein said electronic device communicates the drone's location directly to a controller on board the drone.

6. The method of claim 1 wherein said communication services are BlueTooth.

7. The method of claim 1 wherein said communication services are WiFi.

8. The method of claim 1 wherein said communication services are Internet.

9. The method of claim 1 wherein said communication services are infrared.

10. The method of claim 1 wherein said electronic device is a PC.

11. The method of claim 1 wherein said electronic device is a smart mobile device.

12. The method of claim 1 wherein said electronic device is a proprietary device.

13. In an electronic device having means for communicating wirelessly through the internet to a remote internet protocol address, means for determining a latitude and longitude of said drone, means for communicating over a cellular network, and means for controlling the internal electronics of said electronic device, a method of guiding the movements of a drone within an airspace comprising the steps of:
a. loading geographic information representing a land tract into said electronic device;
b. calculating a geographic boundary comprising a perimeter of said airspace; and
c. continuously monitoring said drone's geographic position within said land tract and issuing a notification warning upon the transit of said geographic boundary.

14. The method as recited in claim 13, further including the step of downloading a land tract file into said electronic device.

15. The method as recited in claim 14, further including the step of loading geographic boundary information of restricted airspaces within said flight path and issuing a notification warning upon the transit into one of said restricted airspaces.

16. The method as recited in claim 14 further including the step of loading geographic boundary information of restricted airspaces within said flight path and correcting the drone's flight path to prevent it from crossing the designated geographic boundary into a restricted airspace.

17. The method of claim 16 where said correction is automatic.

18. The method of claim 16 wherein said correction includes landing the drone.

19. The method of claim 16 wherein said correction includes hovering near the boundary.
